(19) United States
(12) Patent Application Publication
(10) Pub. No.: US 2005/0104251 A1
(43) Pub. Date: May 19, 2005

(54) Integrated circuit chip packaging process

(75) Inventor: Ming Hsiung Liu, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Lingsen Precision Industries, Ltd., Taichung (TW)

(21) Appl. No.: 10/714,906

(22) Filed: Nov. 18, 2003

(51) Int. Cl. B29C 31/00

(52) U.S. Cl. 264/272.17

(57) ABSTRACT

An integrated circuit chip packaging process includes the steps of: (a) preparing a ceramic substrate having sub-substrates, each sub-substrate having connecting pads, and then attaching a respective die on each of the sub-substrates; (b) electrically connecting the dies at the sub-substrates to the pads; (c) putting the die-attached ceramic substrate in a cavity of a first die of a mold, and then closing a second die of the mold on the first die by the way of not contacting the second die to the substrate to form an enclosed mold cavity in the mold, and then filling a molten encapsulating material into the enclosed mold cavity to form a molding on the top side of the substrate so as to encapsulate the sub-substrates and the die at each the sub-substrate.

### BACKGROUND OF THE INVENTION

1. Field of the Invention

The present invention relates to a posterior IC fabrication procedure and, more particularly, to an IC chip packaging process.

2. Description of the Related Art

A conventional lead frame-based IC chip packaging procedure comprises the steps of Die-Attach, Wire-Bond, Molding, Deflashing, Plating, Laser Marking, Trimming, Forming, Singulating, Testing, and Packing. An IC chip package made according to this procedure has a thickness not less than 1.1 mm, and the connecting leads are exposed to the outside. IC elements made according to this procedure cannot meet quality requirements for small-size RF audio/video products (mobile telephones, PDA, etc.) that require.

Therefore, low thickness IC chip packaging procedures commonly use ceramic substrates as a base material. A ceramic substrate has a plurality of sub-substrates for the mounting of individual dies. After installation of individual dies, gold wires are bonded to electrically connect the dies to predetermined locations at the sub-substrates, and then a predetermined amount of encapsulating material is coated on the substrate over the die at every sub-substrate by screen printing. After hardening of the encapsulating material, the substrate is properly cut to singulate the sub-substrates, forming individual low-thickness IC elements.

Because a ceramic substrate is fragile, the molding process of the aforesaid conventional lead frame-based IC chip packaging procedure cannot be employed to encapsulate a ceramic substrate. However, the encapsulating process of screen printing cannot easily keep the top face of the packaged IC element smooth, not suitable for mass production.

Therefore, it is desirable to provide an integrated circuit packaging procedure that eliminates the aforesaid problems.

### SUMMARY OF THE INVENTION

It is the primary objective of the present invention to provide an integrated circuit chip packaging process, which is practical for use in the manufacturing of an IC chip package using a ceramic substrate, for example, a RF IC package to encapsulate the substrate rapidly by a method similar to a conventional molding process.

To achieve this objective of the present invention, the integrated circuit chip packaging process comprises the steps of: (a) preparing a ceramic substrate having a top side on which a plurality of sub-substrates are provided, said sub-substrates each having a die mounting zone and a plurality of pads around said die mounting zone, and attaching a respective die on the die mounting zone of each said sub-substrate; (b) electrically connecting the dies at said sub-substrates to said pads; (c) preparing a mold comprised of a first die and a second die, and then putting the die-attached ceramic substrate thus obtained from said step (a) and step (b) in a cavity of the first die of said mold, and then closing the second die of said mold on said first die by the way of not contacting said second die of said mold to said die-attached ceramic substrate to form an enclosed mold cavity in said mold, and then filling a molten encapsulating material into said enclosed mold cavity to form a molding with a predetermined height on the top side of said ceramic substrate, thereby encapsulating said sub-substrates and the die at each said sub-substrate; and (d) opening said mold and taking out the encapsulated die-attached ceramic substrate thus obtained from said step (c), and then cutting the encapsulated die ceramic substrate to singulate said sub-substrates into individual.

### BRIEF DESCRIPTION OF THE DRAWINGS

FIG. 1 is a block diagram showing the operation flow of an integrated circuit chip packaging process according to the present invention.

FIG. 2 is a top view of a ceramic substrate according to the present invention.

FIG. 3 is a top view of a sub-substrate according to the present invention.

FIG. 4 is a bottom view of the sub-substrate shown in FIG. 3.

FIG. 5 is a sectional view taken along line 5-5 of FIG. 3.

FIG. 6 is a schematic drawing showing a semi-finished product after die-attaching procedure and wire-bonding procedure according to the present invention.

FIG. 7 is a schematic drawing showing the formation of a molding in the mold on the top side of the ceramic substrate according to the present invention.

FIG. 8 is a schematic drawing showing an intermediate molding plate sandwiched in between the bottom die and the top die of the mold and a molding formed in the mold on the top side of the ceramic substrate according to the present invention.

### DETAILED DESCRIPTION OF THE INVENTION

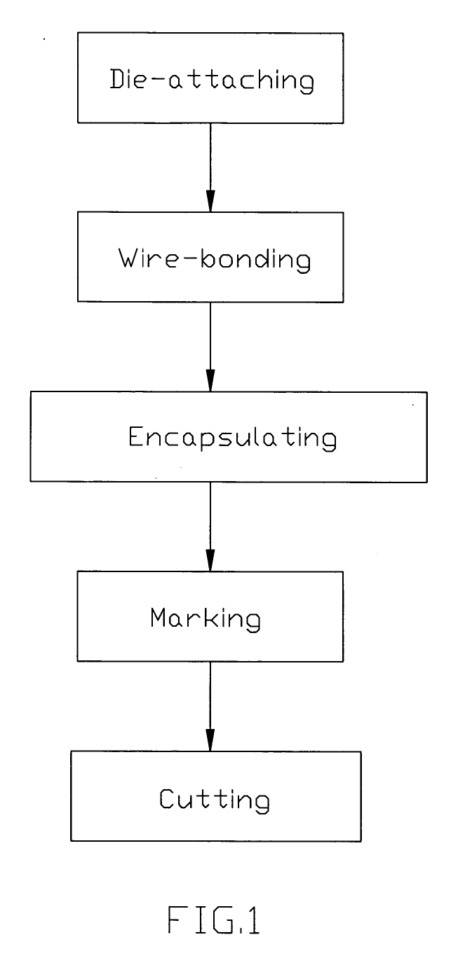

Referring to FIG. 1, an integrated circuit chip packaging process in accordance with the present invention includes die-attaching procedure, wire-bonding procedure, encapsulating procedure, marking procedure, and singulating procedure.

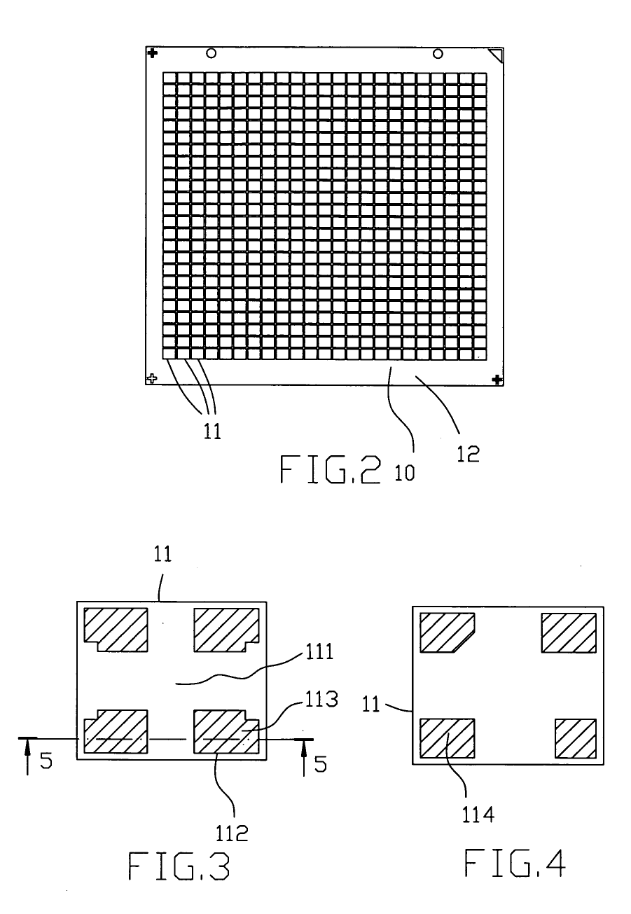

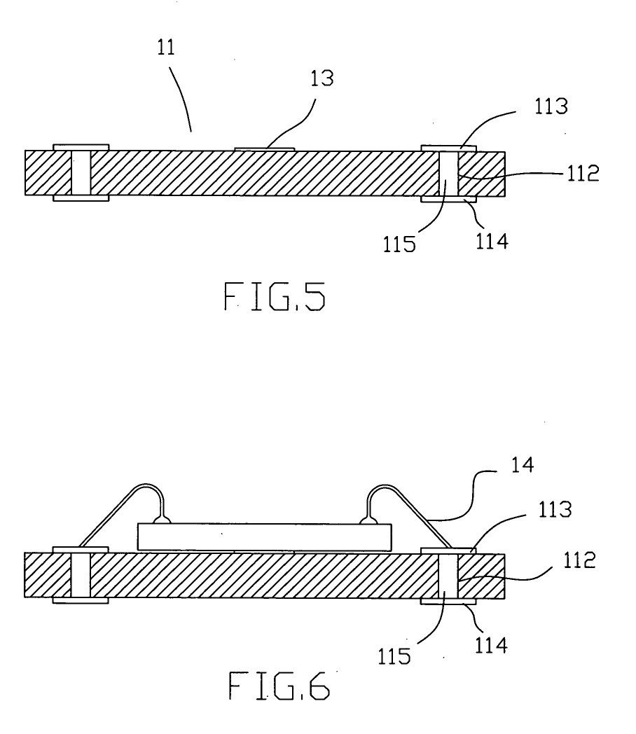

The die-attaching procedure includes the steps of preparing a ceramic substrate 10. As shown in FIG. 2, the ceramic substrate 10 comprises an array of sub-substrates 11 arranged on the top side thereof, an endless surrounding portion 12 extended around the four sides of the array of sub-substrates 11. As shown in FIGS. 3 and 4, each sub-substrate 11 has a die mounting zone 111 at the center of one side, namely, the first side, four connecting pads, i.e. gold fingers 112, respectively disposed in the four corners. Each gold finger 112 comprises an inner bonding portion 113 disposed at the first side of the sub-substrate 11, an external bonding portion 114 disposed on the opposite side, namely, the second side of the sub-substrate 11, and a connecting portion 15 cut through the first and second sides of the sub-substrate 11 and electrically connected between the inner bonding portion 113 and the external bonding portion 14.

Referring to FIG. 5, the die mounting zone 111 of each sub-substrate 11 is covered with a layer of silver paste 13, and then individual dies are respectively bonded to the silver paste 13 at the die mounting zone 111 of each sub-substrate 11. Thereafter, the substrate 10 is baked in a baking oven at about 175° C. for about 60 minutes.

Referring to FIG. 3, the wire-bonding procedure is to connect the contacts at the individual dies to the inner bonding portions 113 of the gold fingers 112 of the sub-substrates 11.

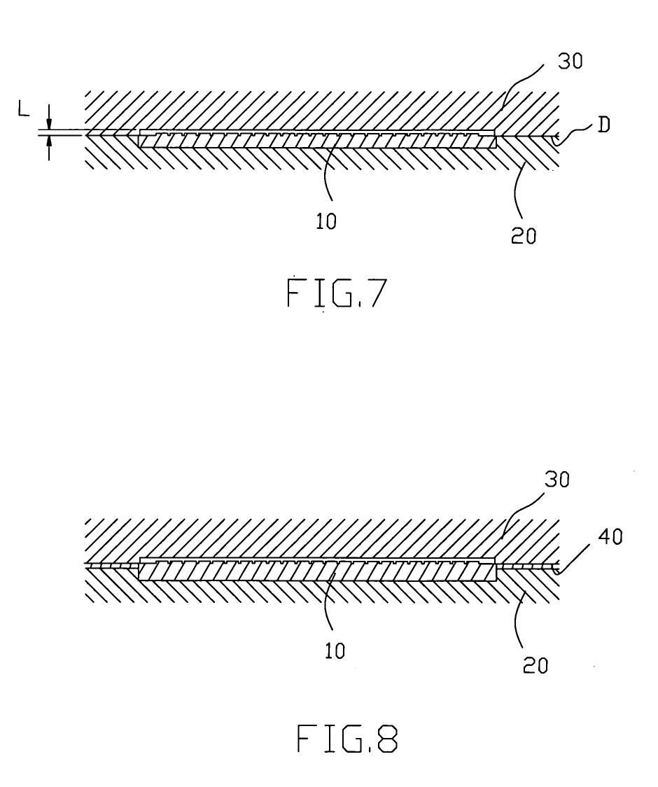

Referring to FIG. 7, after the wire-bonding procedure, the ceramic substrate 10 is put in the cavity of a first die, namely a bottom die 20, of a mold by the way of facing the top side of the ceramic substrate up. The peripheral side of the cavity of the bottom die 20 is approximately equal to the size of the ceramic substrate 10. The depth of the cavity of the bottom die 20 of the mold is slightly greater than the thickness of the ceramic substrate 10. Thereafter, a second die, namely a top die 30, of the mold is covered on the reference plane D at the bottom die 20 of the mold. Since the depth of the cavity of the bottom die 20 of the mold is slightly greater than the thickness of the ceramic substrate 10, when the bottom die 20 and the top die 30 of the mold are closed, the top die 30 of the mold does not touch the ceramic substrate 10 directly, giving no pressure to the ceramic substrate 10. The peripheral side of the cavity of the top die 30 is slightly smaller than the cavity of the bottom die 20. Thereafter, molten thermosetting resin is filled into the enclosed mold cavity, which is formed of the bottom die 20 and the top die 30, to encapsulate the top side of the ceramic substrate 10. In other words, the molding formed by the molten thermosetting resin after curing will only encapsulate the top side of the ceramic substrate 10, which has the sub-substrates and the die at each the sub-substrate, and will not cover the lateral periphery of the ceramic substrate 10. The molding formed to encapsulate the ceramic substrate 10 fits the depth L of the cavity of the top die 30 of the mold. In actual practice, as shown in FIG. 8, an intermediate molding plate 40 may be sandwiched in between the bottom die 20 and the top die 30 of the mold to adjust the depth of the cavity of the top die 30 (i.e., to adjust the height of the molding of thermosetting resin on the top side of the ceramic substrate 10). The thickness of the intermediate molding plate 40 is determined subject to the designed molding of thermosetting resin to be formed on the ceramic substrate 10, i.e., a relatively thicker intermediate molding plate 40 is used if the combined thickness of the ceramic substrate and the die is relatively thicker. On the contrary, a relatively thinner intermediate molding plate 40 is used if the combined thickness of the ceramic substrate and the die is relatively thinner.

1. An integrated circuit chip packaging process comprising the steps of:
(a) preparing a ceramic substrate having a top side on which a plurality of sub-substrates are provided, said sub-substrates each having a die mounting zone and a plurality of pads around said die mounting zone, and then attaching a respective die on the die mounting zone of each said sub-substrate;
(b) electrically connecting the dies at said sub-substrates to said pads;
(c) preparing a mold comprised of a first die and a second die, and then putting the die-attached ceramic substrate thus obtained from said step (a) and step (b) in a cavity of the first die of said mold, and then closing the second die of said mold on said first die by the way of not contacting said second die of said mold to said die-attached ceramic substrate to form an enclosed mold cavity in said mold, and then filling a molten encapsulating material into said enclosed mold cavity to form a molding with a predetermined height on the top side of said ceramic substrate, thereby encapsulating said sub-substrates and the die at each said sub-substrate; and
(d) opening said mold and taking out the encapsulated die-attached ceramic substrate thus obtained from said step (c), and then cutting the encapsulated die ceramic substrate to singulate said sub-substrates into individual.

2. The integrated circuit chip packaging process as claimed in claim 1, further comprising the sub-step of putting an intermediate mold plate in between said first die and said second die during said step (c) before filling a molten encapsulating material into said enclosed mold cavity.

3. The integrated circuit chip packaging process as claimed in claim 1, wherein the size of the cavity of said second die is smaller than the cavity of said first die.
